(19) United States
(12) Patent Application Publication
(10) Pub. No.: US 2024/0284818 A1
(43) Pub. Date: Aug. 29, 2024

(54) DEVICE FOR THE INDIVIDUAL DISTRIBUTION OF MATERIAL PARTICLES

(71) Applicant: Hubert Hornung, Unterschneidheim-Zoebingen (DE)

(72) Inventor: Hubert Hornung, Unterschneidheim-Zoebingen (DE)

(21) Appl. No.: 18/571,134

(22) PCT Filed: Jun. 15, 2022
(86) PCT No.: PCT/EP2022/066351

§ 371 Date: Dec. 15, 2023

(30) Foreign Application Priority Data
Jun. 18, 2021 (DE) 102021115886.9
Jun. 15, 2022 (WO) PCT/EP2022/066351

(51) Int. Cl. A01C 7/04; A01C 7/14

(52) U.S. Cl. CPC A01C 7/04; A01C 7/14

(57) ABSTRACT

The invention relates to a device (10) for metering or individually distributing material particles (S), in particular seeds and/or fertilizer, onto agricultural land, comprising at least one storage container which has at least one chamber in the storage container interior for storing loose material particles in bulk form, at least one individualizing device (20) which protrudes into the chamber of the storage container and which has a driven transport means (22) with at least one bucket receiving area (24) for receiving a specified quantity of material particles (S) from the loose material particles in bulk form in the chamber, in particular an individual material particle (S), wherein the driven transport means (22) is designed to guide the at least one bucket receiving area (24) through the material particles in bulk form and convey at least one material particle (S) received in the bucket receiving area (24) out of the chamber opposite the gravitational force (G). The at least one bucket receiving area (24) is releasably connected to the driven transport means (22).

The present application claims the priority of German patent application no. 10 2021 115 886.9, the content of the latter being completely incorporated herein by reference.

The invention relates to a device for metering or individually distributing material particles, in particular seed and/or fertilizer, on agricultural land, having at least one storage container which in the interior thereof has at least one chamber for storing loose material particles in bulk form.

Devices for singularizing seed are known in principle, for example from DE 1 582 116 A which discloses a single-grain seeder having a storage container that in the lower region thereof has a cellular disk which forms a part of the base of said storage container and is mounted on a sleeve that is fastened in the container. Uniformly distributed cells are disposed on the cellular disk and terminated downward by way of a cover disk which is provided with a degree of play. Furthermore, seed guide tubes, which are arranged according to the cells, are fixedly connected to the cellular disk and rotate in an imaginary frustoconical envelope and the free end of said seed guide tubes forms the grain exit location. The options for adaptation and modification of the device to suit customer requirements are limited when a rigid cellular disk is used.

A device for singularizing and for sowing seed grains from a seed grain mass is also known from DE 81 20 598.8 U1, said device having a seed container of which the base is a rotatably mounted distributor disk that is able to be driven and in the proximity of the periphery along said base has at least one series of through bores which on the upper side of the distributor disk have an indentation for receiving in each case one seed grain. A distributor housing is disposed on the container, the periphery of the distributor disk rotating away below said distributor housing. An apparatus for discharging the seed grains located in the indentations of the through bores into distributor lines is disposed below the distributor disk in the region of the distributor housing, said distributor lines leading to a sowing shaft. The apparatus comprises a plurality of ejector pins, the diameter of the latter being somewhat less than the available width of the through bore within the distributor disk. The options for adaptation and modification of the device to suit customer requirements are also limited in this device.

A rotating conveyor disk of a metering or sowing unit is known from DE 10 2014 216 370 A1 said conveyor disk having a plurality of clearances for transporting grain. The conveyor disk rotates within a housing of a metering unit for granular material such as seed grains, fertilizer or the like. The conveyor disk on the external circumference has at least one clearance for receiving at least one grain to be separated over at least one revolution of the conveyor disk. The at least one clearance, when interacting with a groove-shaped contour feature of the inner envelope face, forms a conveyor pocket for conveying one grain or a plurality of grains in the direction of an outlet opening that adjoins the inner envelope face in an approximately tangential manner. The at least one clearance is located on the external circumference of the conveyor disk in an insert element which is releasably anchored in the disk. As is also the case with the publications mentioned at the outset, the options for adaptation and modification of the device to suit customer requirements are also limited in this device.

Furthermore known are seed material singularization devices which are based on a pressure gradient or on compressed air.

Known from EP 3 050 419 A1, for example, is a metering device of an agricultural machine for the individual dispensing of granular materials in the form of grains, for example seed, fertilizer or the like. The metering device herein operates according to the pressure differential principle. The metering device herein comprises a housing having a grain infeed and a seed material reservoir in a chamber. A metering member, which is rotatably disposed and has clearances, disposed regularly on a curved path, for receiving grains delimits the chamber. The clearances connect the chamber to a region with a lower pressure level. Grains are inducted by the clearances as a result of the pressure difference, said grains subsequently being conveyed along the curved path to a grain delivery region by the rotation of the metering member. A pressure level in the grain delivery region forms an induction airflow by way of which the grains experience a change in direction in the direction of a guide path of a guide element in the direction of a seed material metering line. Moreover, as a result of an airflow in the seed material metering line, the grains experience active acceleration.

The use of negative pressure and thus the effect of induction in the singularization of material particles such as seed poses the risk of the accumulation of disruptive particles or foreign matter between the particles to be singularized. The disruptive particles, or foreign matter, herein can occupy the space of the material particles to be singularized in the singularization apparatus, or displace the latter. Consequently, particles other than the desired material particles are discharged in the direction of the agricultural land. This can lead to a non-uniform distribution of the material particles. Furthermore, disruptive particles such as dirt, metal shavings, rocks or similar foreign matter can cause damage to the machine if they are being permanently deposited.

A further solution for singularizing spherical particles is described in DE 201 13 941 U1. Here, the spheres are singularized by means of a vibrating apparatus in the storage container and directed onward into pipes, the spheres there remaining on top of one another in storage. For unloading or conveying the spheres, an airflow which conveys the spheres in the conveyor lines to the drop-off points is generated by way of a fan.

Finally, U.S. Pat. No. 2,770,440 discloses a solution of a singularization apparatus with a conveyor belt, while DE 10 2004 042 519 A1 discloses a device for wiping off excess seed grains from the sowing openings of an individual grain seeder, said sowing openings being attached in a rotating drum or disk and being impinged with a pressure difference.

An object of the present invention thus lies in providing an improved device for metering or individually distributing material particles, which enables a reliable, precise and variable distribution of material particles and at the same time reduces wear on the components.

In order for this object to be achieved, a device for the individual distribution of material particles having the features of patent claim 1 is proposed.

According to one aspect of the invention, a device for metering or individually distributing material particles, in particular seed and/or fertilizer, on agricultural land is proposed, having at least one storage container which in the interior thereof has at least one chamber for storing loose material particles in bulk form, and having at least one singularization apparatus which protrudes into the chamber of the storage container and has a driven transport means having at least one scoop receptacle for receiving a predefined quantity of material particles from the loose material particles in bulk form in the chamber, in particular a single material particle. The driven transport means here is configured to guide or move (receiving) the at least one scoop receptacle through the loose material particles in bulk form, and to convey count to gravity at least one material particle received in the scoop receptacle out of the chamber (transporting), wherein the at least one scoop receptacle is releasably connected to the driven transport means. Depending on the type of material particles to be distributed, it may also be desirable to provide a predefined quantity of material particles (metering).

Using a device of this type it is possible to deposit, or to distribute, a predefined quantity, in particular individual material particles such as seed grains and/or fertilizer particles, uniformly on agricultural land. The focal point of the invention herein lies in the simplified singularization of the material particles, or in providing the latter in a predefined quantity (metering), respectively. The receiving of the material particles from the loose material in bulk form and the transport of the material particles from the supply container via the singularization apparatus to a downstream delivery apparatus by way of the solution according to the invention take place in a particularly gentle manner and substantially by utilizing gravity. The scoop receptacle which is guided through the loose material in bulk form is loaded with the predefined quantity of material particles, in particular with one material particle, under the effect of gravity. The at least one material particle is received in the at least one scoop receptacle and is held by gravity, and is conveyed out of the chamber to a predefined delivering point by the transport means. In the region of the delivering point, the at least one material particle is transferred to a delivery apparatus, for example under the effect of gravity.

In principle, the device according to the invention permits material particle singularization, or material particle metering, and distribution without the required use of pneumatically operated components. A further focal concept of the present invention thus lies in that the known use of negative pressure or compressed air for singularizing the seed can be dispensed with, if this is desired.

In principle, it is of course also possible, if desired by the customer, to optionally dispose additionally pneumatic components in the delivering apparatus, i.e. downstream of the singularization apparatus, or in parallel with the singularization apparatus, as a result of which a distribution which is at least partially based on compressed air or negative pressure is made possible. As opposed to known solutions in which negative pressure is used, dirt particles and foreign matter in the device for the individual distribution of material particles can additionally be dispensed externally via the delivery device with the aid of compressed air. It is also possible for the delivery from the singularization apparatus to the delivery apparatus to be facilitated by using compressed air, negative pressure, or a combination thereof.

The scoop receptacle is designed as a protrusion which in a state connected to the transport means projects from the latter and has a receptacle clearance for receiving the at least one material particle. Furthermore, the scoop receptacle, in a manner similar to a scoop, can have a head region having a clearance pointing away from the base for receiving (receptacle clearance) the at least one material particle, or the defined material particle quantity, and a web region for connecting to the transport means. As in the case of a scoop, the clearance can be configured as a depression (trough) having a depressed base area, and a periphery that at least partially delimits the depression. The clearance herein can also be laterally open, for example in that the periphery is interrupted, lowered or the like in the region of the free end. Moreover, the web region does not have to be designed narrower or wider than the head region, but can transition flush in the latter. Also, the head region, in particular the receptacle, does not have to be disposed so as to be axially symmetrical in relation to a longitudinal axis of the web.

According to a refinement of the invention it can be provided that the depressed base area of the receptacle clearance has at least one through bore for the flow of a fluid, in particular air, to pass through the receptacle clearance. A particularly simple and gentle treatment of the material particles is again made possible by the fluid-supported output of the at least one material particle from the scoop receptacle via the through bore. Should air not be used as fluid, other fluids, i.e. liquids or gases, which may also otherwise be advantageous in the context of outputting seed and/or fertilizer, can be used, for example liquid fertilizer that wets the seed immediately prior to sowing, liquid or gaseous pesticides, or comparable solutions.

The depressed base area herein can additionally be configured with a fluid routing in such a manner that a fluid flow flowing in through the at least one through bore is guided with the fluid routing entirely or in a plurality of partial flows, for example two partial flows, in the receptacle clearance and as a result directs the at least one received material particle in its desired orbit from the receptacle clearance of the scoop receptacle into the free-fall region. The fluid routing can be configured by projecting structures on the surface of the depressed base area and in the peripheral region of the receptacle clearance, wherein different shapes and designs (with for example flutes, elevations, wedge-shaped protrusions and the like) may be expedient depending on the material particles to be received.

The air supply can be fed by means of a separate device which can be designed to be adjustable, in particular in terms of its relative height and in terms of its inclination relative to the scoop receptacle. In this way, the device can deliver compressed air to the scoop receptacle, which compressed air flows as an airflow at a predefined angle of attack into the through bore of the scoop receptacle, and is optionally deflected and/or divided in a targeted manner in the interior of the receptacle so as to support the desired orbit of the at least one material particle to be delivered out of the scoop receptacle.

The scoop receptacle can be screwed or snap-fitted to the assigned transport means. For example, the web region can have an external thread or a fastening opening with an internal thread here, which is screwed into a corresponding internal thread in a fastening opening of the transport means or into a corresponding external thread (for example on a fastening pin or the like) on the transport means. An analogous snap-fit connection (or a comparable, easily releasable type of connection) is also conceivable and enables easy releasability and connectability of the scoop receptacle on the transport means.

It can be achieved by the easy releasability and connectability of the scoop receptacle on the transport means that the device is easy to adapt to different material particles to be singularized, or material particle quantities to be output. Furthermore, an easy and rapid repair can be performed in the event of damage. Finally, in the case of a plurality of scoop receptacles on a transport means, the number and arrangement can also be easily varied depending on the specific application.

According to a refinement of the invention it can be provided that the singularization device has at least two transport means which in terms of their movement speed (and correspondingly in terms of the driving rotating speed of an assigned drive unit) are able to be driven in a mutually independent manner. Alternatively or additionally, it can be provided that the device according to the invention in one embodiment comprises a plurality of singularization devices. This results in that a plurality of transport means are thus provided in such a way that the distribution procedure, i.e. the output of the material particles (for example when fertilizing or sowing) becomes more efficient. By providing at least two transport means (one singularization apparatus or a plurality of singularization apparatuses), two or more material particles, in particular seed or else fertilizer particles, can be deposited in one and the same row, or in a plurality of parallel rows. In the process, the singularized material particles can be deposited or output by way of a common downstream delivery apparatus, or by way of a plurality of delivery apparatuses which are assigned to a respective transport means or to a respective singularization device.

Furthermore, the at least two singularization apparatuses, or the at least two transport means, can be able to be separately switched on and off, i.e. the drive of the transport means of the respective singularization apparatus can in particular be able to be switched on and off. Switching on and switching off can take place mechanically or electronically, in particular also in a controlled manner. As a result, a specific quantity of the required seed per area (kg/ha) and/or of the required fertilizer can easily be calculated and correspondingly adapted.

It can furthermore be provided that the at least two transport means are disposed so as to be mutually parallel, independently of whether they are assigned to the same singularization apparatus or to at least two singularization apparatuses.

With a view to a modular construction of the device, it can be provided that each singularization apparatus is assigned to a respective chamber and conjointly with the latter configures a singularization module which can be operated independently of optionally further provided, respectively other singularization modules.

Independently of whether a modular construction of the device is provided, or else in combination therewith, provided according to the invention can be a common drive which drives all transport means (independently of the assignment to one or a plurality of singularization apparatuses), or a common drive for the transport means of a singularization apparatus or optionally for the transport means of a singularization module. For this purpose, a direct connection to the transport means, or an indirect connection which is established by way of a switchable transfer box, for example, can be provided. In this way, in a simple design embodiment, all transport means of the device, or all transport means of a singularization apparatus or of a singularization module, can be driven at the same rotating speed by the assigned common drive.

The drive herein can in turn be driven by a simple roller which runs conjointly on the ground, i.e. for example the agricultural land (field) and is driven by a displacement (traveling movement) of the device along the ground in such a way that an additional drive unit can be dispensed with. In this case, a predefined ratio between the traveling speed of the device during the output of the material particles on a field and the running speed of the transport means (and thus the output rate) is predefined.

A further conceivable design embodiment provides that a common drive is performed by way of a drive unit, such as a drive motor, and thus drives the transport means independently of the traveling speed of the device. Such a drive can in turn be controlled, for example by means of an electronic control unit or computer control unit and/or a mechanical control unit. Such a control unit makes it possible to adapt the quantity of the output material particles, for example seed or fertilizer particles, when in motion.

In the case of a transfer box, the drive torque of the common drive (independently of the design thereof) can be distributed to the individual transport means, or drive means of the transport means, of a singularization apparatus, or of a singularization module at a fixed or a variable ratio. In the case of a variable ratio, the gear ratio can be changed by a switchable gearbox. It can also be provided that a transport means is switched off in that the drive means of the transport means is coupled or decoupled by way of the transfer box.

Moreover, instead of a common drive for the plurality of transport means of the singularization units, it is also conceivable to provide a plurality of separate individual drives which are assigned in a mutually independent manner to a respective transport means so as to drive the latter. Here too, at least one individual drive can be controllable.

As a result of the possibility—however designed—to operate the individual transport means in a mutually independent manner in terms of their driving rotating speed, be it by switching on and off the individual drives in a common drive and/or by adapting the gear ratio in the transfer box or by providing independent individual drives, it is possible to deposit a different number of material particles in each row. This is advantageous in particular in the case of different soil qualities.

According to one design embodiment of the invention it can be advantageous to configure a plurality of chambers, or chamber partitions, in the interior of the storage container. For this purpose, additional containers, for example interchangeable plastics containers, can be disposed in the interior, for example, wherein the chambers are delimited by the walls of the containers. Furthermore, the chambers can be configured by the use of suitable partition walls. Alternatively, it is possible to delimit the chambers within the storage container in the form of partition walls which are integrally molded on the storage container. According to the number of chambers provided, the number of delivery openings provided in the base part of the storage container can be adapted in such a way that, for example, each chamber is assigned a delivery opening in the base part. By providing a plurality of chambers within the storage container it is possible to store different material particles in bulk form in the chambers, for example seed particles of different seed types, or seed particles in a first chamber as well as fertilizer particles in a second chamber.

The at least two transport means of the at least two singularization apparatuses can be disposed according to the invention in parallel, as has been mentioned above, or so as to be mutually offset.

As has already been explained above, in the case of a parallel arrangement, a common drive which optionally drives a plurality of individual drives of the transport means which can be switched on and off can optionally be used. In a particularly simple design embodiment, the transport means disposed in parallel are thus conjointly driven by one drive. Depending on the design embodiment, by providing a gearbox the drive can be distributed among a plurality of individual drives which can be switched on and off, as a result of which it becomes possible to actuate the individual singularization apparatuses and thus transport means autonomously.

The plurality of singularization apparatuses can be fed from a single chamber or a plurality of chambers. Independently thereof, or in combination therewith, the device can have at least one wiper apparatus by means of which excess material particles, which protrude beyond the scoop receptacle, for example, can be wiped off into the assigned chamber in order to ensure that the predefined quantity of material particles is received in the scoop receptacle. Depending on the design embodiment of the particle feed as an individual chamber, or having a plurality of chambers or chamber partitions, and depending on the particles received therein, a single wiper apparatus may be provided, which may also be expedient in the case of a plurality of chamber partitions disposed in parallel, or each chamber or chamber partition can be assigned a separate wiper element.

The wiper apparatus can comprise at least one wiper element which can be configured as a mechanical wiper element and which by mechanical wiping is able to wipe off from the scoop receptacle excess material particles exceeding the predefined quantity of material particles to be received in the scoop receptacle. In this way, the wiper element can be configured for example in the form of a brush element, a textile element, or an elastic element in the form of a rubber lip, an elastic silicone strip or the like. The elastic deformation capability of the bristles of a brush element, of the textile or elastic element or elements, make it possible that excess material particles are wiped off in a particularly gentle manner.

However, the wiper apparatus can also comprise a fluid flow, wherein the excess material particles can be blown away by the fluid used, for example by means of compressed air, and fall back into the chamber from the scoop receptacle. As has been described in the context with the delivery of the material particles from the scoop receptacle above, other fluids may also comprise other gases or liquids than air.

In the case of at least one mechanical wiper element, the latter can act passively, i.e. be fixedly disposed at a location along which the at least one scoop receptacle moved by the transport means is moved past, for example, and passively wipe (slide) across the moving scoop receptacle. Alternatively however, the at least one mechanical wiper element can also be driven so as to perform, for example, a rotating and/or oscillating movement relative to the transport means. Combinations of a passive effect (for example a freely rotating roller) and an active effect (which is able to reciprocate in a driven oscillating manner) are also conceivable.

Of course, the wiper apparatus may also comprise in combination with one another a plurality of mechanical wiper elements (actively and/or passively) and/or a fluid flow. In this way, a brush element as a passive or active mechanical wiper element can also be combined with a compressed-air jet, for example.

It is furthermore conceivable to adapt the number of transport means to the number of chambers provided, and vice versa. In a design embodiment having two chambers, it is possible to singularize and deliver in a singularized manner the material particles stored in the first chamber by means of a first transport means, and to singularize and deliver in a singularized manner the material particles stored in the second chamber by means of a second transport means. In this way, the material particles can be transported, in each case separately from one another, in the direction of a common delivery apparatus, or in the direction of separate delivery apparatuses. Depending on whether the material particles are in each case transported separately from one another in the direction of a common delivery apparatus or in the direction of separate delivery apparatuses, said material particles can be deposited in mutually parallel rows or in a common row. Moreover, it is possible to deposit different material particles, in particular seed and fertilizer, in a mutually separate manner.

Even in a non-parallel arrangement of the transport means it is made possible to deposit material particles of the same or of another type sequentially in one and the same row on the agricultural land by way of the two separate transport means.

Material particles of the same type can be supplied from one and the same chamber of the storage container by means of two independent transport means, or in the case of a non-modular construction of two singularization apparatuses.

The transport means can be controlled and operated simultaneously or autonomously independently of their arrangement with one another.

In the case of a parallel arrangement, the targeted switching on or off of a transport means correspondingly allows a row to be switched off. This makes it possible for the user to deposit next to one another different material particles, for example different seed types, or seed and fertilizer particles, in a targeted manner.

In the case of a non-parallel arrangement, or when two transport means transport the material particles to the same delivery apparatus, the addition of specific material particles and/or the quantity of material particles that are to be deposited in a row, can likewise be regulated.

If a plurality of transport means, including (a) downstream delivery apparatus or delivery apparatuses are provided, the user can thus define different spacings between the individual material particle rows on the agricultural land by switching on or off, or additionally switching on, the individual transport and delivery lines in a targeted manner.

It can be advantageous to size one of the transport means, in particular a revolving conveyor belt, in terms of its width in such a manner that a multiplicity of scoop receptacles are able to be releasably fastened to the same transport means, for example in rows. In such a design embodiment, the scoop receptacles can be fastened to the transport means in the plurality of rows having different spacings between the receptacle clearances, i.e. the spacings between the scoop receptacles in a first row differ from the spacings between the scoop receptacles of a second row, for example. In this way, different numbers of scoop receptacles can be provided in the individual rows, for example 100 scoop receptacles in a first row, 50 scoop receptacles in a second row, and 30 scoop receptacles in a further row. Accordingly, different quantities of material particles can be output in the rows of a single transport means. The scoop receptacles herein can be fastened to a transport means in a uniformly distributed manner. Should this be desired, the scoop receptacles can also be fastened to a transport means in a nonuniformly distributed manner, i.e. have different spacings from one another in a first row, for example.

Alternatively, the transport means can in each case also have only one row having a plurality of scoop receptacles. In the case of a plurality of transport means, the spacings between the scoop receptacles in the individual transport means can also be chosen to be of different sizes here in such a way that the individual transport means can have different numbers of scoop receptacles, as has been explained above.

As a result of the design embodiment of the present invention having a plurality of transport means, the respective spreading rows can be switched on and off separately. It is made possible as a result to select a desired row spacing.

Alternatively or additionally, it can be provided that the transport means of the singularization device, in particular the revolving conveyor belt, is guided by way of a first and a second shaft, wherein the first shaft comprises in particular a drive shaft, and the second shaft comprises in particular a deflection shaft for the revolving conveyor belt.

The drive shaft can additionally be provided with toothed elements or comparable protrusion-like structures (studs or the like) which for the purpose of improved driving interacts with the transport element or mating structures configured on the transport element. The interaction between toothed elements (or comparable structures) and the mating structures of the transport element can take place, for example, by an at least partial engagement between the toothed elements or comparable protrusion-like structures in corresponding mating structures on the revolving conveyor belt, so as to guarantee a better transmission of force and torque between the drive shaft and the transport element. The first and the second shaft can be disposed on two mutually parallel axes. Alternatively, the axes can be at an angle to one another. Furthermore, it can be advantageous to guide the transport element by way of more than two shafts. This depends in particular on the respective design embodiment of the singularization apparatus in terms of construction and space. As an alternative to guiding the transport element by way of at least one shaft, the one transport element can be disposed so as to slide on a ring-shaped roller track, wherein the transport element is able to be driven by way of a suitable drive element, for example a gear wheel provided with toothed elements.

The first shaft or the second shaft (or an optionally additional shaft, for example a deflection shaft) herein can mark a reversal point or reversal region at which the at least one material particle received in the scoop receptacle is no longer held in the scoop receptacle by gravity, and in a free-fall region falls in the direction of the ground under the effect of gravity.

In this embodiment it can furthermore be provided that the delivery apparatus has at least one distributor duct which proceeding from the free-fall region runs in the direction of the land and is optionally able to be impinged with compressed air.

The singularized material particles in the free-fall region are delivered in the direction of the at least one delivery apparatus. By delivering the material particles to the delivery apparatus in a defined free-fall region, in which the at least one material particle received in the scoop receptacle is no longer held in the scoop receptacle by gravity, but falls downward under the effect of gravity, it is guaranteed that the material particles are supplied to the delivery apparatus in a defined number, or at a defined cycle rate. It is only as a result that a uniform delivery in the direction of the agricultural land, or a uniform distribution of the particles, is made possible. When a plurality of scoop receptacles are disposed on the transport means, uniform or dissimilar spacings may be provided between the scoop receptacles.

According to a further design embodiment of the invention, the material particles which lie outside the at least one scoop receptacle of the transport means may be able to be returned, after wiping off by a wiper element, to the storage container by means of a return apparatus, wherein the return apparatus can comprise in particular a compressed-air duct.

Accordingly, a wiper element by means of which the excess material particles present (for example outside the scoop receptacle) can be wiped from the transport element, or the scoop receptacle, can be provided in the proximity of the free-fall region. The wiper element can be configured as a mechanical wiper element (wiper brush, elastic wiper strip, or the like) and/or as a wiper element with a fluidic action, as has already been described above. In the case of a mechanical wiper element which extends in the vertical direction toward the transport element, said mechanical wiper element can be in a slight sliding contact with the transport element and/or the scoop receptacle connected to the latter (passive effect) and/or be actively moved. The sliding contact on the part of the wiper element can be configured by plastic and/or textile fringes or elements configured on the wiper element. The wiped-off material particles can then be returned into the storage container by means of a return apparatus. The return apparatus can be configured as a channel and/or trench to which a compressed-air feed is assigned, as a result of which the material particles are returned in the compressed-air flow in the direction of the chambers of the storage container. Should a plurality of transport means be present, each of the transport means can preferably be assigned one wiper element and one return apparatus, for example. This enables a separate return feed to the chamber even when different material particles are being used.

Alternatively or additionally, the design embodiment of the scoop receptacle and the guiding of the scoop receptacle by means of the transport means can also be designed in such a way that the scoop receptacle in a predefined region in front of the free-fall region is already inclined in such a manner that only the predetermined quantity of material particles, or only one material particle, can be held in the scoop receptacle by gravity, and any excess slips from the scoop receptacle and falls back into the chamber. This solution represents a particularly simple and cost-effective variant in which further components for wiping off can be dispensed with.

According to a further optional design embodiment of the invention, the delivery apparatus comprises at least one distribution duct which proceeding from the free-fall region runs in the direction of the land and is able to be impinged with compressed air. This distribution duct can open into a plurality of hoses which convey the singularized material particles for spreading on the agricultural land, or a plurality of ducts can be provided for a plurality of hoses.

According to a further design embodiment of the invention, the size, in particular the depth, width and/or length of the receptacle clearance, of the at least one scoop receptacle can be designed so as to be adaptable to the size of the (at least one) material particle to be received. For this purpose, it can be provided to design the scoop receptacle so as to be adaptable in size in an elastically elongating manner, or mechanically. A mechanical adaptation can be changed by inserting shaped pieces into the scoop receptacle, or by increasing or decreasing the diameter of the clearance in a manner initiated by a screw, similar to the principle of a screw-action clamp. The same applies to the adaptability of the fluid routing in the interior of the scoop receptacle, which may also be designed to be adaptable by using inserts, for example. It can be achieved as a result that the device is readily individually adaptable to customer requirements.

According to a further design embodiment of the invention, the singularization apparatus comprises a vibration inducer. The latter can comprise an apparatus which emits individual compressed-air pulses. A design of the vibration inducer by way of an apparatus which enables short-term vibration likewise comes into consideration. The vibration inducer is preferably disposed in or on the singularization apparatus in such a way that a vibration or compressed-air pulse introduced into the latter likewise facilitates the release of excess material particles from the scoop receptacle and/or the delivery from the scoop receptacle into the free-fall region.

According to a further advantageous design embodiment of the invention, the device is able to be fastened to a commercial vehicle, preferably an agricultural vehicle.

It is to be pointed out additionally that terms such as “comprising”, “have” or “with” do not preclude any other features or steps. Furthermore, terms “a” or “the”, which indicate a singular number of steps or features, do not preclude a plurality of features or steps, and vice versa.

Further features and advantages of the invention are derived from the description hereunder of a plurality of exemplary embodiments of the invention, and from the dependent claims.

The invention is described in more detail hereunder with reference to the appended figures. The figures show a plurality of features of the invention in combination with one another. Of course, however, the person skilled in the art is also able to consider these features in a mutually independent manner and to potentially combine them so as to form further expedient sub-combinations without having to undertake any inventive steps to this end.

In the figures, schematically:

FIG. 1 shows a device according to the invention for the individual distribution of material particles in an isometric view;

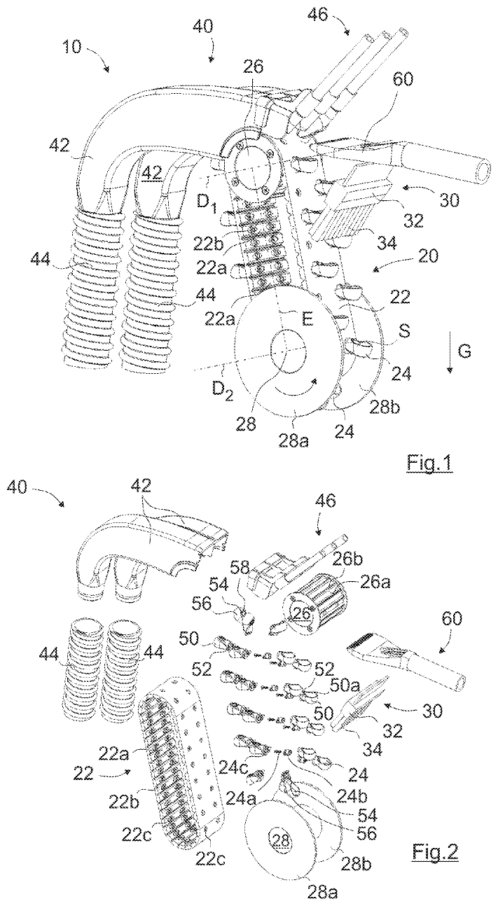

FIG. 2 shows the device according to FIG. 1 in an exploded illustration;

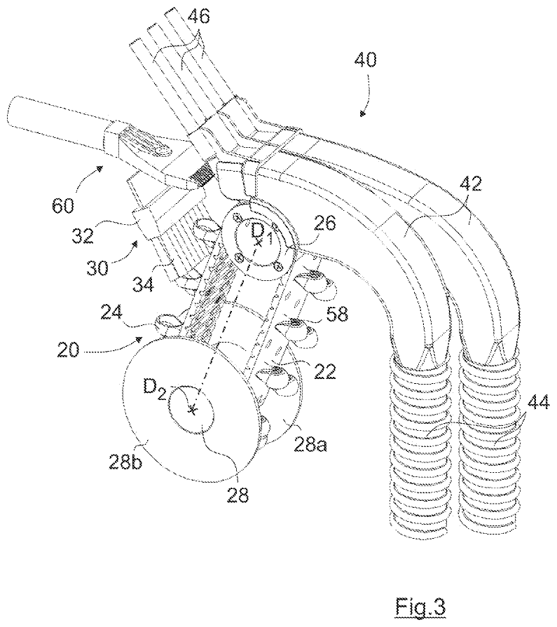

FIG. 3 shows the device of FIGS. 1 and 2 in a position rotated in relation to FIG. 1;

FIG. 4 shows a comparison of different variants of a scoop receptacle of the device according to the invention in a view from above;

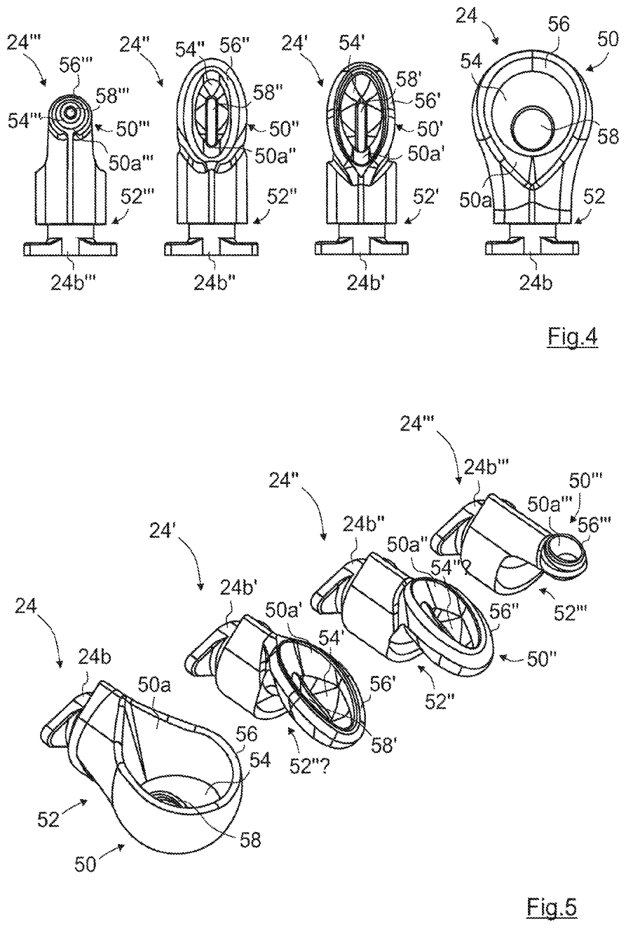

FIG. 5 shows a comparison of different variants of a scoop receptacle of the device according to the invention in an isometric view;

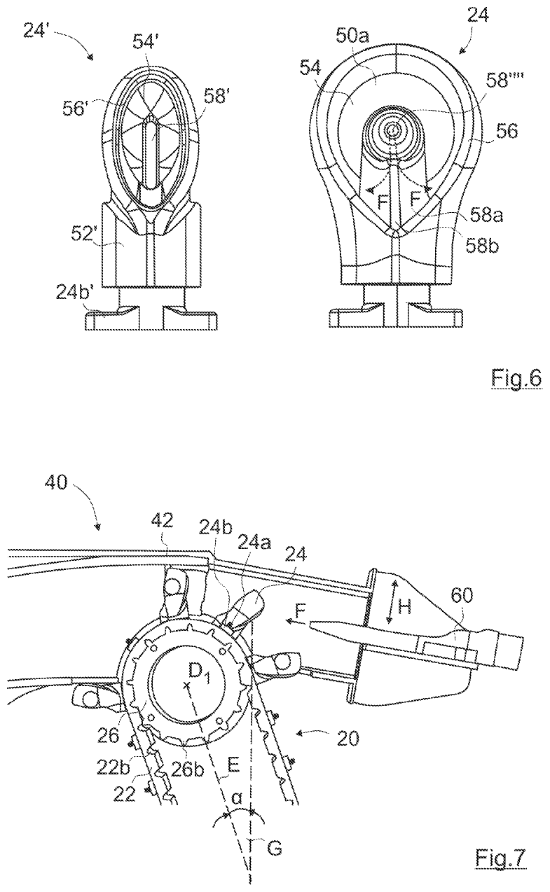

FIG. 6 shows a comparison of different variants of a scoop receptacle of the device according to the invention in a view from above; and

FIG. 7 shows a fragment of the device according to the invention of FIGS. 1 to 3 in a lateral view.

The figures show by way of example an embodiment of the invention in a simplified schematic illustration. The device for metering and individually distributing according to the present invention herein is provided with the reference sign 10, and may be able to be fastened in a known manner to a commercial vehicle, preferably an agricultural vehicle (not illustrated).

The device 10 herein is composed substantially of three components: a singularization apparatus 20 having a transport means 22 so as to convey material particles S out of a storage container (not illustrated), and having a multiplicity of scoop receptacles 24 so as to singularize a predefined quantity of material particles S, in particular individual material particles S as shown, from a material particle in bulk form received in the storage container, a delivery apparatus 40 to which the singularized material particles S can be handed on and by means of which the singularized material particles S are delivered to the agricultural land, and a wiper apparatus 30 so as to release excess material particles S from the singularization apparatus 20. A compressed-air distribution apparatus 60 can be additionally provided, as in the embodiment shown.

The singularization apparatus 20, as has already been described, comprises a transport means 22 which in the embodiment shown is configured as a revolving conveyor belt. For example, the conveyor belt 22 can be configured from a textile or elastic basic material, for example rubber, and have insert elements, for example of metal or a load-bearing plastics material, which serve for stabilizing the conveyor belt in the longitudinal direction (for example using steel wires or cables), and for fastening the scoop receptacles 24 (for example in the form of insert elements which are disposed transversely to the direction of movement and are identified by the reference sign 22a in FIG. 1). Alternatively, a transport belt or a transport chain may also be provided, wherein fastening elements for fastening the scoop receptacles can be provided on the chain links, for example.

The conveyor belt 22 shown, by virtue of the insert elements 22a, has an internal structure 22b with groove-like depressions between the individual insert elements 22a, this moreover enabling an improved transmission of force of the driving force from a drive shaft 26 to the conveyor belt. In this way, a mating structure 26b, for example in the form of web-shaped protrusions which are able to engage in the groove-like depressions of the internal structure 22b, is provided on the external side 26a of the drive shaft 26.

The drive of the drive shaft 26 is not shown here. As has been discussed in the general introduction of the description, a raft of variants are conceivable in this context.

Fastening receptacles 22c, which are presently configured as through bores and serve for fastening the scoop receptacles 24 to the transport means (cf. also FIG. 2), can be seen on the external side of the conveyor belt 22. Alternatively, other design variants are also conceivable, for example threaded bores as fastening receptacles which do not have to be designed to penetrate.

In the embodiment shown it is also seen that not all fastening receptacles 22c are populated with a scoop receptacle 24, and a plurality of rows (in the figures two rows) of fastening receptacles 22c having identical spacings in the revolving direction of the conveyor belt are provided. Of course, instead of two rows, more or fewer rows of fastening receptacles 22c can also be provided, having identical spacings or dissimilar spacings in the revolving direction of the conveyor belt. The population of the fastening receptacles 22c is variable and can thus be adapted to the material particles (seed, fertilizer) to be metered and singularized. Moreover, scoop receptacles of different sizes and shapes for different material particles (seed, fertilizer) to be metered and singularized can be releasably fastened to the fastening receptacles.

The scoop receptacles 24, the structure thereof being discussed in more detail hereunder, for fastening to the transport means have fastening means 24a, 24b in the form of a screw 24a and an insert 24b, both being inserted into the fastening receptacles 22c from the internal side of the conveyor belt and engaging in a corresponding threaded bore 24c on the scoop receptacle so as to form a releasable screw connection therefor. Alternative releasable fastening mechanisms, such as clipping or snap-fitting the scoop receptacles 24 onto or into corresponding fastening structures on the transport means are of course likewise conceivable.

The scoop receptacles 24 comprise a head region 50 and a web region 52. The head region 50 serves for receiving the material particle or particles S (in the embodiment shown for receiving a single material particle S) and for this purpose has a receptacle clearance 50a (cf. FIG. 2) which is sized and shaped in such a manner that the latter is able to receive exactly one single material particle S of a specific average size (e.g. a rapeseed grain). It is moreover seen in FIG. 2 as well as in FIGS. 4 to 6 that the clearance 50a is delimited by a periphery 56 and has a depressed base area 54 in the manner of a trough. The latter has a through bore 58 so as to enable a flow of air or another fluid to pass through the receptacle clearance 50a.

Depending on the type of material particles (seed, fertilizer) to be metered and singularized, the size and shape of the receptacle clearance 50a may vary, as a result of which the device 10 can be adapted to the most varied specific applications (cf. FIGS. 4 to 6, the same reference signs are used herein for the same features and have one or more apostrophes depending on the variant, e.g. 24, 24′, 24″ and 24′″). For this purpose, the releasably fastened scoop receptacles 24 can be easily interchanged or in terms of their size of the receptacle clearance 50a and/or the through bore 58 or 58″″ be adapted by additional inserts 58a (FIG. 6). It is also furthermore seen that in FIG. 6, in the region of the depressed base area 54, a fluid routing structure 58b is provided by the insert 58a, this fluid routing structure 58b achieving a deflection and targeted separation of the fluid flow flowing in through the through bore 58″″ (indicated by the two arrows identified by F in FIG. 6). As a result, a targeted shape of the fluid routing or air routing within the scoop receptacle 24 is achieved, which enables the received material particle to be routed onward in an optimal manner. Accordingly, scoop receptacles 24 having a laterally open receptacle clearance 50a (in which in a region of the periphery 56 is interrupted or lowered) or having alternative through bores and fluid routing structures can also be used. The fluid routing structure can of course also be configured directly on the internal surface of the clearance 50a of the scoop receptacle 24.

The web region 52 serves for connecting to the transport means and on its free end has the threaded bore 24c already described. The web region 52 can be narrower than the head region 50, as in the embodiment shown, be flush in this transition or be configured wider.

The scoop receptacles 24 can be composed of a metallic material, of plastics material, or of a combination thereof, for example of a metallic web region and a head region composed of plastics material, wherein the web region can be insert-molded in the plastics material of the head region.

The transport means 22 is finally guided by way of a further second shaft 28, the latter conjointly with the first shaft 26 tensioning the conveyor belt 22 and guiding the revolving movement of the latter.

Not shown is the arrangement of the singularization apparatus 20 in a chamber of a storage container which serves for storing a loose material particle in bulk form (to be distributed). It is primarily decisive that the scoop receptacles 24 of the singularization apparatus 20 are guided through the material particle in bulk form in such a manner that said scoop receptacles 24 are able to receive (can be populated with) the at least one material particle S in the receptacle clearance 50 of said scoop receptacles 24. Accordingly, the second shaft 28 can be rotatably mounted or supported, for example, as a freely rotating deflection shaft in the chamber, for example by way of the bearing flanges 28a, 28b which are attached laterally to said second shaft 28. At the same time, these bearing flanges 28a, 28b are dimensioned in such a manner that the scoop receptacles can revolve freely in the assembled state. Accordingly, these bearing flanges 28, 28b can also be assembled so as to be interchangeable on the second shaft 28, so as to enable an adaptability to scoop receptacles 24 of dimensioned with different sizes.

Furthermore, depending on the specific application, the angle α (cf. FIG. 7), of the straight lines of extent E of the transport means, formed by the two rotation axes D1 and D2 of the first and the second shaft 26 and 28, and of the axis of orientation of gravity G can also be varied by the choice of the size of the bearing flanges 28a, 28b. This angle α can be chosen to be between 0° (perpendicular arrangement) up to 60°, but usually rather up to 45°. The acting gravity (which holds the material particle S in the receptacle clearance 50a) and the ejection point (also reversal point) at which the material particle S and falls into a free-fall region in which said material particle S is no longer supported by the scoop receptacle 24, are influenced by the orientation of the straight lines of extent E.

The orbit of the material particle S herein depends on the design embodiment of the scoop receptacle, the movement speed of the transport means and the chosen injection point, and can additionally be influenced by the infeed of a fluid, for example compressed air. In the embodiment shown, a compressed-air distribution apparatus 60 is provided for this purpose, which delivers compressed air in a targeted manner to the fastened scoop receptacles 24 at the reversal point thereof, said compressed air flowing through the provided through bores 58 of the scoop receptacles and in this way enabling an improved release of the received material particles S and at the same time participating in determining the orbit of the material particles S. In order to also ensure an optimal flow onto and through the respective scoop receptacles 24, which deviate from one another in terms of size (for example FIGS. 4 to 6), the compressed air distribution apparatus 60 is disposed so as to be height-adjustable (indicated by the double arrow H in FIG. 7).

The device 10 moreover comprises the wiper apparatus 30 so as to release excess material particles S from the singularization apparatus 20. This wiper apparatus 30 in the embodiment shown is configured as a mechanical wiper element in the form of a wiper brush. Said wiper brush can act passively in that the latter is assembled in a fixed position on a part of the device 10 and slides across the singularization device 20. Alternatively however, said wiper brush can also act actively in that the latter is moved relative to the transport means, for example moved in an oscillating manner transversely to the revolving direction of the conveyor belt 22.

Finally, the device 10 comprises the delivery apparatus 40 which in the embodiment shown is connected directly to the singularization apparatus 20 and has two distribution ducts 42 with associated distribution hoses 44. The number of distribution ducts 42 and of connected distribution hoses 44 shown here are chosen purely by way of example, and may also comprise more than two or fewer than two. The distribution ducts 42 in the embodiment shown are impinged with compressed air F which is blown in by the compressed-air supply 46. Alternatively, a suction unit can also be disposed in the lower region of the ducts or hoses, which generates a negative pressure for supporting the orbit of the material particles S.

The present device enables simple, reliable and particularly gentle metering and singularizing of the most varied material particles, as a result of which the device can be used in a wide field of application in the agricultural sector. The simple and uncomplicated adaptability of said device enables seed and/or fertilizer to be spread in a manner highly specific to the application, this permitting this technology to be able to be used in changing soils, or changing soil quality in terms of nutrients, foreign matter, etc., and to be able to ensure in the process that each sown plant receives sufficient nutrients over time.

The embodiment shown in the figures represents the invention in a simplified embodiment in order to be able to explain the functional mode thereof by visualization. The mechanisms shown herein can be provided in large numbers, depending on the working width of the seeder. Furthermore conceivable is a modular construction having different storage containers in such a way that different seed types and/or fertilizers can be spread simultaneously. The individual modules can be operated independently of one another and allow the most varied applications.

1. A device (10) for metering or individually distributing material particles (S), in particular seed and/or fertilizer, on agricultural land,
having at least one storage container which in the interior thereof has at least one chamber for storing a loose material particle in bulk form,
having at least one singularization apparatus (20) which protrudes into the chamber of the storage container,
and has a driven transport means (22) having at least one scoop receptacle (24) for receiving a predefined quantity of material particles (S) from the loose material particle in bulk form in the chamber, in particular a single material particle (S),
wherein the driven transport means (22) is configured to guide the at least one scoop receptacle (24) through the loose material particle in bulk form, and to convey counter to gravity (G) at least one material particle (S) received in the scoop receptacle (24) out of the chamber,
wherein the at least one scoop receptacle (24) is releasably connected to the driven transport means (22),
wherein the scoop receptacle (24) is designed as a protrusion which in a state connected to the transport means (22) projects from the latter and has a receptacle clearance (50a) for receiving the at least one material particle (S), and
wherein the receptacle clearance (50a) is configured in the manner of a depression having a depressed base area (54) and a peripheral portion (56) that at least partially delimits the depression, characterized in that the depressed base area (54) of the receptacle clearance (50a) has at least one through bore (58) for a flow of fluid, in particular air, to pass through the receptacle clearance (50a).

2. The device (10) as claimed in claim 1, wherein the scoop receptacle (24) has a head region (50) with the receptacle clearance (50a), and a web region (52) for connecting to the transport means (22).

3. The device (10) as claimed in claim 1 or 2, wherein the depressed base area is additionally configured with a fluid routing in such a manner that a fluid flow flowing in through the at least one through bore is guided with the fluid routing entirely or in a plurality of partial flows, for example two partial flows, in the receptacle clearance, wherein the fluid routing is in particular formed by projecting structures on the surface of the depressed base area and in the peripheral portion of the receptacle clearance.

4. The device (10) as claimed in one of the preceding claims, wherein the singularization device (20) has at least two transport means (22) which in terms of their movement speed are able to be driven in a mutually independent manner, and/or wherein the device (10) as claimed in one of the preceding claims has at least two singularization devices (20).

5. The device (10) as claimed in claim 4, wherein the at least two transport means (22) are disposed so as to be mutually parallel.

6. The device (10) as claimed in claim 4 or 5, wherein each singularization apparatus (20) is assigned to a respective chamber and conjointly with the latter forms a singularization module which can be operated independently of the respectively other singularization modules.

7. The device (10) as claimed in one of the preceding claims 3 to 6, wherein the device (10) has a common drive which is provided to drive the at least two transport means (22), wherein the latter are connected to the drive via a transfer box.

8. The device as claimed in claim 7, wherein the transfer box comprises a switchable gearbox.

9. The device (10) as claimed in one of the preceding claims, wherein the singularization device has at least one wiper apparatus (30) by means of which excess material particles (S) can be wiped off into the assigned chamber so as to ensure that the predefined quantity of material particles is received in the scoop receptacle (24).

10. The device (10) as claimed in claim 9, wherein the wiper apparatus (30) comprises at least one mechanical wiper element (32).

11. The device (10) as claimed in claim 10, wherein the mechanical wiper element (32) is movable so as to rotate and/or oscillate relative to the transport means, and/or comprises a brush element.

12. The device (10) as claimed in one of the preceding claims, wherein the singularization device has a multiplicity of scoop receptacles (24) which are releasably connected to the assigned transport means (22), and wherein the assigned transport means (22) comprises a revolving conveyor belt to which the scoop receptacles (24) are releasably fastened.

13. The device as claimed in one of the preceding claims, wherein the at least one transport means (22) of the singularization devices is guided by way of at least one first (26) and a second (28) shaft, wherein the first shaft (26) comprises in particular a drive shaft, and the second shaft (28) comprises in particular a deflection shaft for the revolving transport means (22), and wherein a shaft (26, 28) for guiding the transport means (22) marks a reversal point at which the at least one material particle (S) received in the scoop receptacle (24) of the assigned transport means (22) is no longer held in the scoop receptacle (24) by gravity (G) and falls into a free-fall region.

14. The device as claimed in claim 13, wherein a delivery apparatus (40), disposed downstream of the singularization apparatus (20), comprises at least one distribution duct (42) which proceeding from the free-fall region runs in the direction of the land and is able to be impinged with compressed air.

15. The device (10) as claimed in one of the preceding claims, wherein the size of the at least one scoop receptacle (24) is able to be adapted to the size of the at least one material particle (S) to be received, or the quantity of the material particles (S) to be received.
